(19) United States
(12) Patent Application Publication
(10) Pub. No.: US 2009/0255129 A1
(43) Pub. Date: Oct. 15, 2009

(54) MULTIFUNCTION CARTON TRAY CUTTER

(76) Inventors: Donald GRINGER, New York, NY (US); Yuan Fang Cheng, Forest Hills, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 12/103,247

(22) Filed: Apr. 15, 2008

(51) Int. Cl. B26B 3/08

(52) U.S. Cl. 30/162

(57) ABSTRACT

A guided utility knife that alternates between a carton tray cutter and a conventional utility knife is provided herewith. The knife comprises two rotatable guide portions that are hingedly attached to the housing. Each guide portion flips laterally, away from the cutting blade from its unfolded position to its folded position. Each guide portion further occupies a channel on the exterior surface of the housing. Magnets are provided in the housing to secure the guide portions in both the folded and unfolded positions.

### FIELD OF INVENTION

The present application relates to utility knives. More specifically, the invention involves a guided utility knife for separating a corrugated carton top from its body. Even more particularly, the invention relates to an ambidextrous retractable utility knife having hinged guides, each guide being adapted to slide along a carton surface while a blade cleanly and professionally slices the carton top off to leave a topless carton, in a precise and consistent manner.

### BACKGROUND OF THE INVENTION

Utility knives and in particular box cutting knives have been widely used for a number of years. However, many box cutting knives that are common in the industry suffer from a number of major drawbacks. One drawback for some of the knives, such as the ones disclosed in U.S. Pat. Nos. 5,386,632 and 5,613,300, is that they are constructed to be used by either right- or left-handed individuals, but not both. For example, right-handed versions of such a knife are constructed with an immobile guide that is firmly fastened or, in some cases, integrally molded to the left side of the knife, and conversely, left-handed versions of the knife are constructed with an immobile guide that is fastened to the right side. This requires retail or wholesale establishments that sell or use such utility knives to keep stock of both to suit the needs of individual workmen.

While there exist some guided box cutting knives which provide for use by both right- and left-handed individuals, such as the one disclosed in U.S. patent application Ser. No. 11/735,997 having Pub. No. U.S. 2007/0209209 (“Davis”), many of these have a number of other deficiencies. One deficiency includes the incorporation of guides on either side of the knife that are meant to slide forward as a result of applying pressure to the guide with a thumb. In some instances however, the guides are overly impeded by the construction of the knife as a whole, requiring a larger amount of force in order to slide the guide forward and into a guiding position. When this occurs, a user's thumb may slip forward against a blade that is extended from the cutter, causing a gash or other serious injury to the user. Another deficiency in the Davis knife is that it is grip-activated, that is, when the knife is gripped, the blade is extended. This requires the knife to be held for safety in a holster, and prevents a user from placing it in a pants or apron pocket where the blade may extend if pressure is accidentally applied to the grip while in the pocket.

Yet another problem with Davis is that the guides on either side of the knife do not extend sufficiently forward beyond the edge of the knife housing. In the context of box cutting, this results in guides being routinely driven into and hooking onto the sides of the boxes, rather than proceeding smoothly and easily along the surface of the box as intended. In most instances, this results in uneven cutting of the box, or damage to merchandise inside the box, and/or possibly injury to a user who must use additional force to free the blade and guide from the box.

Another particularly major drawback with current utility knives that have a selectively extendable/retractable guide is that the guide's movement is severely restricted such that it may only extend straight forward and retract straight back, usually parallel to the cutting blade. This restriction may cause severe injury, particularly in the context of forcing the guide rearward into a retracted position. For example, if the cutting blade is extended forward, an unwary user pushing the guide back into its retracted position may force his finger(s) directly onto the sharp blade.

### SUMMARY OF THE INVENTION

In view of the deficiencies and drawbacks in the prior art, it is a primary object of the present invention to provide an improved guided utility knife for use in removing corrugated box tops cleanly and efficiently leaving an open-topped carton while minimizing risk of injury to a user.

Another primary object of the present invention is to provide an improved utility knife with guides that rotate and/or fold towards and fold away from a sharp cutting blade (rather than extending straight forward and retracting straight back) to prevent risk of injury to a user.

Still another object of the present invention is to provide a cutting instrument with selectively rotatable guides that pivot between an extended or unfolded position that allows for precise boxtop cutting, and a retracted or folded position that allows for other conventional utility knife usage.

It is a further object of the present invention to provide an improved utility knife with guides that extend sufficiently forward to prevent uneven cutting, damage to merchandise and unintentional injury to a user.

Yet another object of the present invention is to provide an improved guided utility knife that is suitable for both right- and left-handed users.

Additional objectives will be apparent from the description of the invention that follows.

In summary, there is provided an improved guided utility knife or carton tray cutter comprising a first housing portion and a second housing portion which are selectively separable from one another by use of a releasable housing lock. The first and second housing portions together form an enclosed housing which accommodates a retractable cutting blade. The improved utility knife further comprises a first guide portion and a second guide portion attached to each of the first and second housing portions, respectively. Preferably, each of the first and second guide portions are hingedly and rotatably attached to the first and second housing portions, respectively. Significantly, the pivot connection allows each guide to rotate between an extended or unfolded position, where the guide extends forward beyond the front edge or head of the utility knife, and a retracted or folded position, where the guide is folded back when not in use or to use the device as a conventional utility knife. In a preferred embodiment, each guide is secured both in the extended position and retracted position by one or more magnets located on the housing portion to which the guide is attached. The ability of each guide to rotate laterally, away from the cutting blade when the guide is tucked back into the folded position is particularly advantageous in preventing injuries.

As a carton tray cutter, the device is used to cleanly, precisely and safely cut and remove the tops off corrugated cartons or containers so as to leave a topless carton, as is required in many supermarkets, convenience stores, hardware stores and other venues that receive stock in boxes or bulk containers. By cleanly removing the carton top, a stock clerk is able to label or place price stickers on the items contained in the topless carton without destroying the stability of the remaining open carton. Notably, the carton tray cutter is quickly and safely converted into a conventional utility knife by folding the guide(s) away from the cutting blade. Thus, with the same cutting instrument, a clerk is not only able to remove the carton top to expose a topless carton, but is also able to carve a “cut down tray carton” by slicing the front and sides of the carton in order to display its contents on a shelf for shoppers to see. Similarly, the device may be used to accomplish other tasks for which a conventional utility knife is typically utilized.

### BRIEF DESCRIPTION OF THE DRAWINGS

With reference to the attached drawings:

FIG. 1 is a perspective view of a preferred embodiment of the inventive utility knife showing the top, front and left side thereof, with the left and right guides in a folded position and the blade retracted in the housing (in the safe carrying position);

FIG. 2 is a partial cross sectional view, showing the guide partially rotated from a folded or retracted position toward an unfolded position, taken along line 2-2 of FIG. 1;

FIG. 2A is perspective view of the utility knife with the guide being rotated from a folded or retracted position toward an unfolded position;

FIG. 3 is a perspective view of the utility knife shown in FIG. 1 showing the top, front and right side thereof, with the right and left guides in a folded position and the blade retracted in the housing;

FIG. 4 is a perspective view of the utility knife with the left guide in the unfolded position and the cutting blade partially extended from the housing ready for use as a right-hand tray cutter;

FIG. 5 is a partial cross sectional view, showing the guide partially rotated from an unfolded or extended position toward a folded position, taken along line 5-5 of FIG. 4;

FIG. 6 is a perspective view of the utility knife with the right guide in the unfolded position and the blade partially extended from the housing ready for use as a left-hand tray cutter;

FIG. 7 is a perspective view of the right hand of a right-handed user precisely cutting a corrugated box top with a preferred embodiment of the inventive utility knife with the left guide in an unfolded position;

FIG. 8 is a partial cross sectional, close-up view taken along line 8-8 of FIG. 7 of the thumb area of the right hand of a right-handed user cutting a corrugated box top with a preferred embodiment of the inventive utility knife with the left guide in the unfolded position FIG. 9 is a partial cross sectional, close-up view of a left-handed user cutting a corrugated box top with a preferred embodiment of the inventive utility knife with the right guide in the unfolded position;

FIG. 10 is a top view of the utility knife with both guides in their folded positions and the cutting blade in the fully extended position cutting a corrugated box and being used as a conventional (retractable) utility knife;

FIG. 11 is an alternate embodiment of the utility knife with the actuating button along the top edge; and

FIG. 12 is a preferred embodiment of the blade carrier.

### DETAILED DESCRIPTION OF THE INVENTION

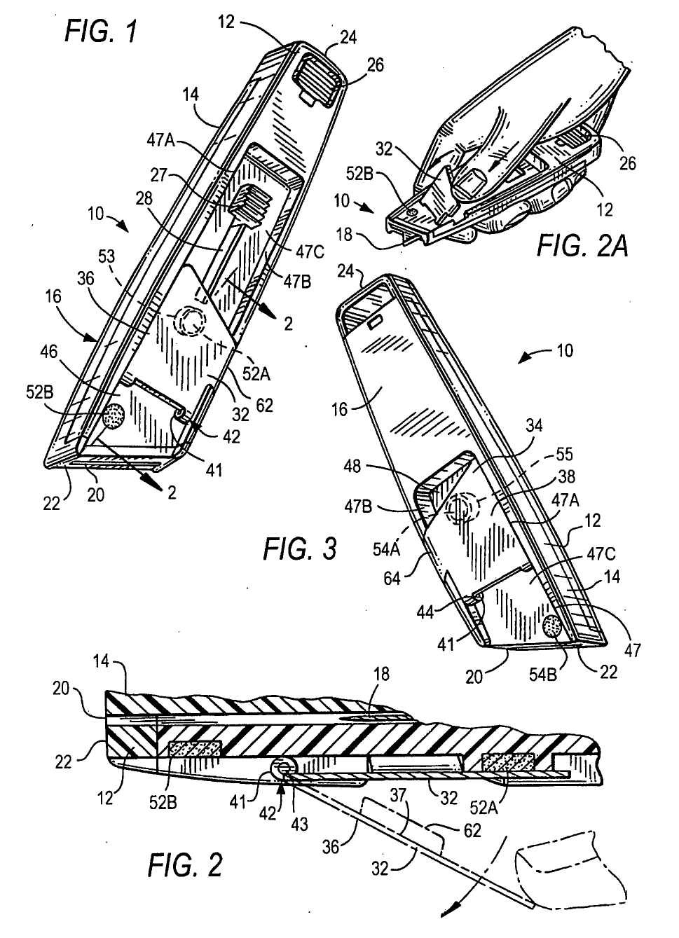

With reference to FIGS. 1 through 10, there is shown a preferred embodiment of the guided utility knife or carton tray cutter 10 having a first housing portion 12 and a second housing portion 14. The first housing portion 12 and second housing portion 14 together form an enclosed housing 16 for accommodating at least one conventional cutting blade 18 which is typically mounted on a plastic carrier, such as the carrier 80 shown in FIG. 12, and which extends from a narrow blade opening 20 at the front end 22 of the guided utility knife 10. The carrier 80 is integrally molded to an actuating button 27 which slides the carrier 80 and blade forward and back along the length of a slot 28 in the first housing portion 12. The housing portions 12, 14 are selectively separable from one another to allow for replacement and storage of cutting blades, and are also secured by a housing lock 26 at the rear end 24 of the utility knife.

Although one preferred embodiment of the knife 10 comprises a side actuating button 27, it should be understood that an alternate embodiment can be created, where the actuating button is placed on top of the knife 110 (rather than on the sides of the knife), as shown in FIG. 1 1. When the button 127 is located on the top of the knife 110, between the two housing portions 112, 114 and/or equidistant from each of the guides 132, 134, the utility knife 110 is used in the same manner by both right- and left-handed users.

Other details regarding the structure, construction and features of housings, blade carriers, releasable housing locks and other components that may optionally be utilized in conjunction with modifications to the preferred embodiment described herein can be found in U.S. Pat. Nos. 5,813,121 and 7,325,313, which are incorporated herein by reference. Furthermore, although the preferred embodiment is shown and described in the context of a guided utility knife 10, 110 having separable housing portions 12, 14, it should be understood that the invention may optionally utilize a non-separable housing or non-separable housing portions as well.

The first housing portion 12 comprises a first guide 32 that is preferably formed of metal or hard plastic material. The broad side 36 of the first guide 32 is substantially smooth and flat to allow the first guide 32 to slide along the top of a carton with relative ease. Optionally, the first guide 32 may have inscribed instructions on either of its broad sides 36, 37, such as “Flip for Right Hand” when the first guide 32 is in the folded position (i.e., on the external side 36 of the first guide 32), or “Hold Down to Cut” when the first guide 32 is in the extended position (i.e., on the internal side 37 of the first guide 32). The foregoing similarly applies to the second guide 34 located at and connected to the second housing portion 14. Each guide 32, 34 may be flipped with either the top or bottom of a finger, and preferably the thumb or index finger.

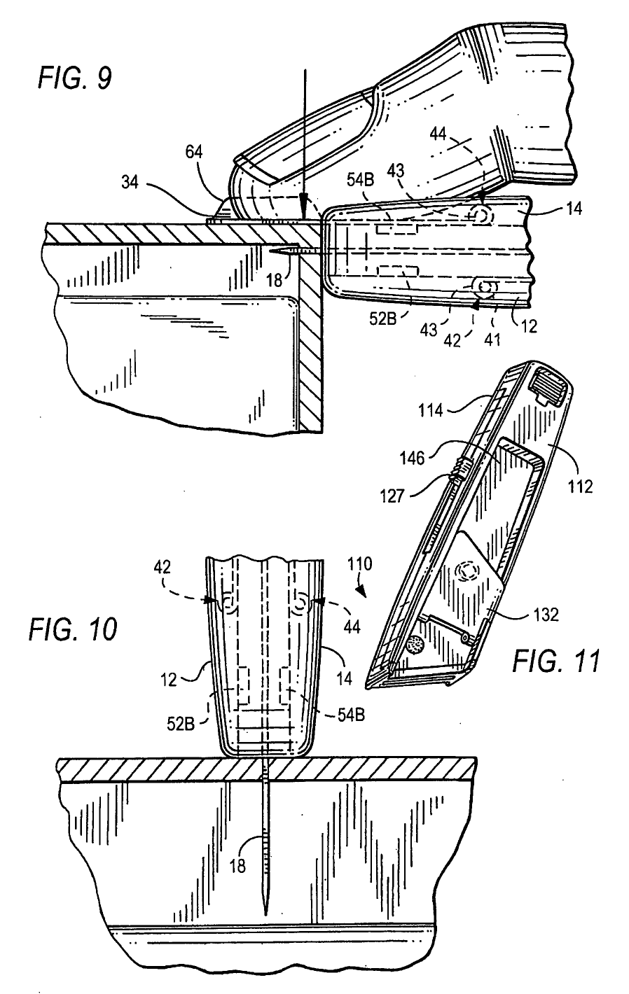

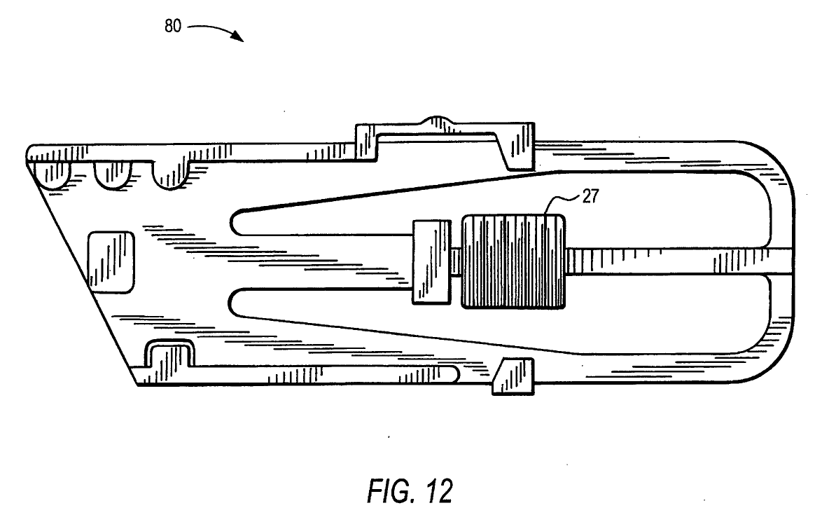

Each of the guides 32, 34 are connected to each of the respective first and second housing portions 12, 14 with hinges 42, 44. In particular, the hinges 42, 44 comprise sockets 41 on the guides 32, 34 which receive pins 43 extending from the respective housing portions 12, 14. Alternatively, it should be understood that the pins may extend from the guides 32, 34, and the housing portions 12, 14 may have the sockets, or optionally, one of each, respectively. As shown in FIGS. 2, 2A and 5, a user simply flips or pivots the guide from the folded position to the extended position with either the thumb or a forefinger, or conversely from the extended position back to the folded position. In so doing, each guide rotates on an axis formed by the sockets and pins. The hinged connection allows the knife 10 to alternate between a standard utility knife when the guides 32, 34 are both folded back, (as shown in FIG. 10 with the blade optionally extended fully forward), and a guided carton tray cutter when one of the guides 32, 34 are extended forward. Furthermore, as previously mentioned, the hinged connections that require a user to outwardly flip the guides 32, 34 laterally and away from the blade help prevent serious injuries by keeping the fingers of the user away from the blade.

The first guide 32 occupies a channel 46 formed in the first housing 12. Likewise, on the opposite side of the utility knife 10, the second guide 34 occupies a channel 48 formed in the second housing 14. Each channel 46, 48 has a top-side wall 47A, a bottom-side wall 47B and a floor 47C. The channel 46 has a length that runs from the front end 22 of the guided knife 10 to a location between the actuating button 27 and housing lock 26. As shown in FIG. 3, since there is no actuating button projecting from the second housing portion 14, the length of the channel 48 in the second housing portion 14 is less than the length of the channel 46 on first housing portion 12 but enough to accommodate the second guide 34.

The broad sides 36, 37 of the first guide 32 occupy the width of the channel 46, allowing enough space for the first guide 32 to rotate or flip between folded and unfolded positions without impediment. When the guide 32 is in the folded position, it is considered to be positioned entirely within the walls 47A, 478 of the channel 46 (even though the bent lead or tongue 62, which is discussed further below, is not within the channel 46). When the guide 32 is in the unfolded position, it remains at least partially, and preferably at least 50%, within the channel. The same likewise applies to the second guide 34 and channel 48.

Within the channel 46 of the first housing portion 12 there are located two magnets 52A, 52B. Rearward magnet 52A is slightly raised within a circular case 53 that is integrally molded to the first housing portion 12. When the first guide 32 is made of metal and is in the folded position, the magnet 52A magnetically holds the first guide 32 in the folded position. Conversely, forward magnet 52B is preferably flush with the first housing portion 14. When the first guide 32 is in the extended position, the magnet 52B holds the first guide 32 in the extended position. In the event that first guide portion is made of plastic or other non-magnetic material, a conventional clip or snap may be utilized in place of a magnet to hold the first guide in place.

Similarly, within the channel 48 of the second housing portion 14 there are two magnets 54A, 54B. Rearward magnet 54A is slightly raised within a circular case 55 that is integrally molded to the second housing portion 14. When the second guide 34 is made of metal and is in the folded position, the magnet 54A magnetically holds the second guide 34 in the folded position. Conversely, forward magnet 54B is preferably flush with the second housing portion 14. When the second guide 34 is in the extended position, the magnet 54B holds the second guide 34 in the extended position. In the event that second guide portion is made of plastic or other non-magnetic material, a conventional clip or snap may be utilized in place of a magnet to hold the first guide portion in place. So that the magnets 52A, 52B, 54A, 54B do not unintentionally magnetically pull the blade from position within the housing when, for example, the housing portions 12, 14 are separated from one another, insulation, such as additional plastic or rubber, is preferably provided on the inside of the housing portions 12, 14. Although the preferred embodiment has two magnets on each of the housing portions 12, 14, it should be understood that a single magnet may be used to keep a guide in the folded position, keep a guide in the extended position, or both.

When the guides 32, 34 are folded back, the slightly raised cases 53, 55 leave a small gap between the internal broad sides 37, 39 (of the first and second guide portions 32, 34) and the channels 46, 48 (of the first and second housing portions 12, 14), respectively. This small gap allows a user to have sufficient leverage and reach with his thumb or other fingers beneath the guides 32, 34 to easily flip them forward when needed, see e.g., FIG. 2A.

The first guide 32 has a corresponding bent lead or tongue 62. The rolled up edge of the tongues 62 helps the knife 10 and first guide 32 glide smoothly and with less friction over the top of a carton as a thumb of a right-handed user is pressed downward applying force against the first guide 32. The second guide 34 has a corresponding bent lead or tongue 64 which functions similarly in the case of a left-handed user.

In the preferred embodiment, when the first guide 32 is in the extended position, the tongue 62 is co-extensive with the front edge 22 of first housing portion 12 (and the bottom-side wall 47 of the channel 46) such that when the first housing portion ends, the tongue begins. This helps ensure that the thumb of a user does not accidentally slip off the knife and injure itself.

In the preferred embodiment, the first housing portion 12 has a pocket or groove 66 in wall 47B and the second housing portion 14 has a pocket or groove 68 in wall 47B. The tongues 62, 64 of the first and second guide portions 32, 34 are curved and fit into the pockets 66, 68 on the first housing portion 12 and second housing portion 14 respectively. Significantly, the curvature of the tongues 62, 64 match or correspond to the side and bottom handle curvature of the first housing portion 12 and second housing portion 14, respectively, such that they do not significantly project outward. This feature allows a user to more easily handle the guided utility knife 10 when the first and second guide portions 32, 34 are folded back.

Notably, the tongue 66 on the first guide 32 serves another function. In particular, when the first guide 32 is in the extended or unfolded position, it is seated adjacent to or against the front end of the second housing portion 14. Since the tongue 66 is hinged to the first housing portion, the housing portions 12, 14 of the knife 10 cannot accidentally separate when the first guide 32 is in the extended position.

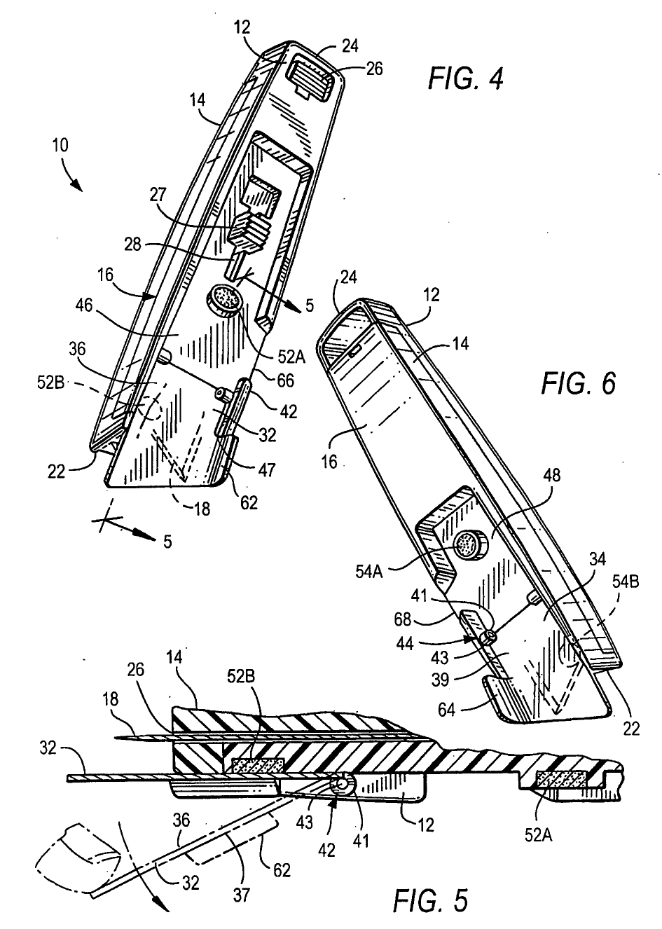

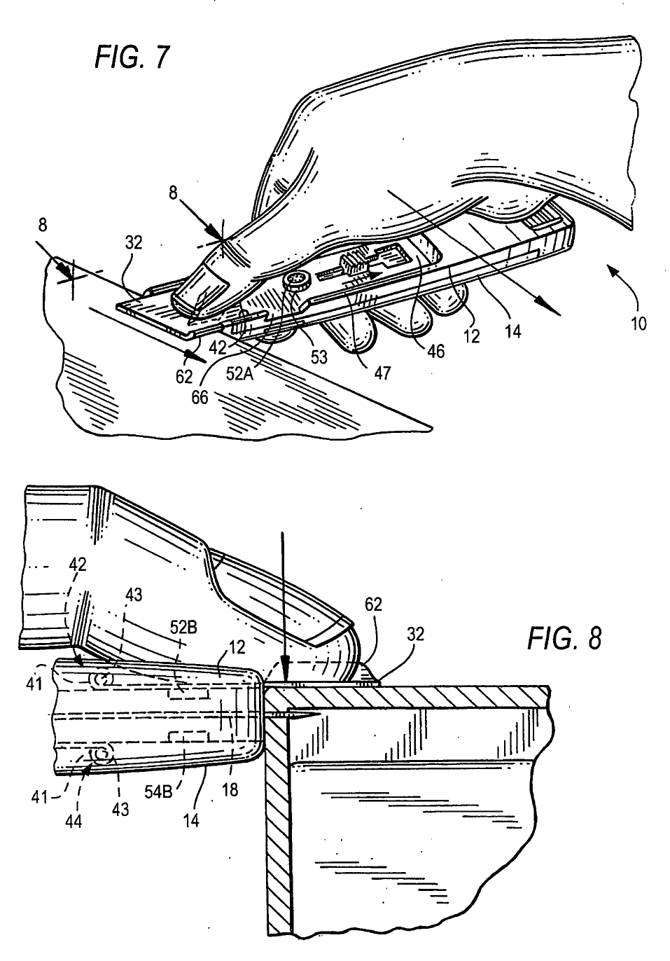

As shown in FIGS. 7 through 9, during use as a carton tray cutter, the blade 18 is extended by means of the actuating button 27 approximately half of its fully extendable length such that it is partially hidden or protected behind the first guide 32, as shown in FIG. 4 (or behind the second guide 34, as shown in FIG. 6 in the case of a left-handed user). After the blade 18 is partially extended, the thumb is placed over the first guide 32, such that the edge of the thumb is positioned at or just shy of the edge of the first guide 32, and the tool 10 is drawn across the top edge of the carton on its four sides. The flat top of the carton is slit on its four sides and removed leaving a “tray” or topless carton, see FIG. 8.

As further shown in FIGS. 7 through 9, when either of the two guides 32, 34 are in the unfolded position ready for carton tray cutting, they are preferably spaced about 3/16 to ¾ of an inch from the extended cutting blade 18. The spacing between the blade 18 and either of the first and second guide portions 32, 34 corresponds to the thickness of the corrugated carton being cut, allowing the blade 18 to cut just below the edge without damaging merchandise as shown in FIGS. 8 and 9. A significant additional amount of space between the guides 32, 34 and the blade 18 would lead to damage or puncture merchandise located in the box that is cut.

Although the invention is described in terms of particular embodiments, it is to be understood that the embodiments are merely illustrative of an application of the principles of the invention. Numerous modifications may be made and other arrangements may be devised without departing from the spirit and scope of the invention.

1. A guided utility knife for use by both right- and left-handed users and for use with a cutting blade, comprising:
a housing, said housing having a left side and a right side and an exterior surface;
a first guide hingedly attached to said left side of said housing, said first guide adapted to rotatably alternate between a first folded position against the housing and a first extended position;
a second guide hingedly attached to said right side of said housing, said second guide adapted to rotatably alternate between a second folded position against the housing and a second extended position;
a first left side magnet located at said left side of said housing for securing said first guide in said first folded position;
a first right side magnet located at said right side of said housing for securing said second guide in said second folded position.

2. The guided utility knife of claim 1, said first guide having a first bent tongue, and said second guide having a second bent tongue.

3. The guided utility knife of claim 2, said left side of said housing having a first groove, and said right side of said housing having a second groove, wherein said first bent tongue fits into said first groove when said first guide is in said first folded position, and said second bent tongue fits into said second groove when said second guide is in said second folded position.

4. The guided utility knife of claim 31 said first tongue and said second tongues being curved, wherein when said first guide is in said first folded position and said second guide is in said second folded position, said first tongue and said second tongue each has a curvature that corresponds to said exterior surface of said housing.

5. The guided utility knife of claim 1, wherein said housing comprises a first channel on said left side of said housing and a second channel on said right side of said housing, wherein said first guide occupies said first channel and said second guide occupies said second channel.

6. The guided utility knife of claim 5, wherein when said first guide is in said first folded position, said first channel is occupied by the entire first guide, and when said first guide is in said first extended position, said first channel is occupied by less than the entire first guide.

7. The guided utility knife of claim 1, wherein said first left side magnet and said first right side magnet are in a raised position relative to said surface of said housing.

8. A carton tray cutter utility knife for use with a cutting blade and for cutting the top of a corrugated carton comprising:
a housing for holding said cutting blade, said housing having a first side, a second side and a first channel, said first channel being positioned at said first side;
a first guide, said first guide being connected to said housing with a hinge and adapted to rotate between a folded position and an unfolded position while being hinged in said first channel;
wherein when said first guide is in said folded position, said first guide is positioned fully within said channel.

9. The carton tray cutter utility knife of claim 8, further comprising a first magnet in said first channel, said first magnet securing said first guide in said folded position.

10. The carton tray cutter utility knife of claim 9, further comprising a second magnet in said first channel, said second magnet securing said first guide in said unfolded position.

11. The carton tray cutter utility knife of claim 10, wherein the first channel has a floor, and further wherein when said first guide is in said folded position, it is in contact with at least one of said first magnet and said floor.

12. The carton tray cutter utility knife of claim 10, wherein the first channel has a floor, and further wherein when said first guide is in said unfolded position, it is in contact with at least one of said second magnet and said floor.

13. The carton tray cutter utility knife of claim 8, said first guide further comprising a first bent lead and said first side comprising a first pocket, wherein when said guide portion is in a folded position, said first bent lead occupies said first pocket.

14. The carton tray cutter utility knife of claim 13, said housing further comprising a curved exterior surface and said first bent lead having a curve that corresponds to said curved exterior surface of said housing when said first bent lead occupies said first pocket.

15. The carton tray cutter utility knife of claim 8, further comprising a second guide and a second channel being positioned at said second side, said second guide being connected to said housing with a hinge and adapted to rotate between a folded position and an unfolded position while being hinged in said second channel.

16. A guided utility knife for use with a cutting blade comprising:
a first housing portion and a second housing portion forming a housing for accommodating said cutting blade;
a first open channel and a second open channel, said first open channel positioned in said first housing portion, and said second open positioned in said second housing portion;
a first selectively rotatable guide hingedly attached within said first open channel to said first housing portion, and a second selectively rotatable guide hingedly attached within said second open channel to said second housing portion, said first guide and said second guide each adapted to rotate between a folded and an unfolded position in said first open channel and said second open channel, respectively.

17. The guided utility knife of claim 16 further comprising at least one magnet in each of said first open channel and said second open channel for holding said first guide portion and said second guide portion in one of said folded position and unfolded position.

18. The guided utility knife of claim 17, said first open channel having a first floor, and said second open channel having a second floor, wherein at least one of said magnets is raised from at least one of said first floor and said second floor.

19. The guided utility knife of claim 16, wherein said first rotatable guide portion has a first bent lead.

20. The guided utility knife of claim 19, wherein said first housing portion has a first groove that is occupied by said first bent lead when said first guide portion is in said folded position.

21. The guided utility knife of claim 20, wherein said first bent lead locks said first housing portion and said second housing portion when said first guide portion is in an unfolded position.

22. The guided utility knife of claim 16 further comprising an actuating button for extending and retracting said cutting blade, said actuating button being located equidistant from each of said first selectively rotatable guide and said second selectively rotatable guide.
